(19) United States
(12) Patent Application Publication
(10) Pub. No.: US 2008/0286738 A1
(43) Pub. Date: Nov. 20, 2008

(54) Method of Detecting Concealed Information

(76) Inventor: Eitan Elaad, Jerusalem (IL)

Correspondence Address: MARSTELLER & ASSOCIATES, P O BOX 803302, DALLAS, TX, 75380-3302, US

(21) Appl. No.: 11/749,690

(22) Filed: May 16, 2007

(51) Int. Cl. G09B 7/00

(52) U.S. Cl. 434/323

(57) ABSTRACT

A method of detecting whether an individual is concealing information by utilizing physiological measurements. The individual is presented with a series of stimuli over a period of time, and the response of the individual is determined by measuring the pulse in the finger of the individual to determine cardiovascular changes during the period. The measurements showing changes in pulse rate and pulse amplitude are graphically represented and analyzed. The finger pulse waveform line length is measured, and the response of the individual analyzed by analyzing the line length to determine whether the individual is concealing information.

### FIELD OF THE INVENTION

The present invention is concerned with individuals who conceal information. More particularly, the present invention relates to the utilization of physiological measurements to determine whether information is being concealed.

### BACKGROUND OF THE INVENTION

Publications and other reference materials referred to herein, including references cited therein, are incorporated herein by reference in their entirety and respectively grouped in the appended Bibliography which immediately precedes the claims.

The Guilty Knowledge Test (GKT), also known as the Concealed Information Test (CIT), is a method of psychophysiological detection of concealed information. It utilizes a series of multiple-choice questions, each having one relevant question (e.g., a feature of the crime under investigation) and several neutral (control) alternatives, chosen so that an innocent suspect would not be able to discriminate between them (Lykken, 1998). Typically, if the suspect's physiological responses to the relevant questions are consistently larger than to the neutral alternatives, knowledge about the event is inferred.

Studies conducted in laboratory settings have indicated that the GKT is a highly valid method for differentiating between guilty and innocent subjects (see Ben-Shakhar & Furedy, 1990, for a review). More recently, Ben-Shakhar and Elaad (2003) conducted a meta-analysis research on GKT studies and showed that under optimal conditions (i,e., using motivational instructions, deceptive verbal response to the relevant items, and at least five GKT questions) the GKT yields impressive efficiency estimates (effect size of 3.12 or an average correlation coefficient of 0.79 between the detection measure and the criterion of guilt versus innocence). It should be pointed out that these impressive detection efficiency indices were obtained with a single physiological measure—Skin Conductance Response (SCR).

Some studies used the respiration line length (RLL), which is a combined measure of respiration amplitude and respiration cycle time, as an additional detection measure (e.g., Ben Shakhar & Dolev, 1996; Elaad & Ben-Shakhar, 1997; Timm, 1982). The RLL provides a global score of respiratory suppression. A combination of the RLL and the SCR resulted in enhanced detection accuracy of the GKT.

A third autonomic measure, typically used in actual polygraph testing, is the cardiovascular measure, which is affected by diastolic blood pressure changes. Sokolov (1963) indicated that vasoconstriction in the limbs and heart rate slowing are components of the orienting response (OR), which is elicited by a novel or significant (signal value) stimulus. Lykken (1974) explained that the relevant questions in the GKT have a special significance for guilty subjects but not for innocent examinees. This added significance of the relevant questions produces a stronger OR than that produced by the non-significant, or neutral alternatives.

Several studies examined cardiovascular activity in relation to concealed information in the GKT, and showed that heart rate (HR) slowing produces better than chance detection rates of guilty knowledge. However, HR was less effective than SCR in this respect (Bradley & Ainsworth, 1984; Bradley & Janisse, 1981; Podlesny & Raskin, 1978). More recently, Godert et al. (2003) demonstrated that HR deceleration within 8 sec. after stimulus onset can be a good predictor of guilty knowledge. Similarly, Verschuere et al. (2004) showed that crime related, or relevant stimuli elicited greater HR deceleration than control items in a GKT. These results corroborate the OR account for the effect observed in the guilty knowledge paradigm.

Differential responding to the relevant stimuli in the GKT can be accounted for by what is known as “sympathetic activation”, which is part of the OR. In many cases such activation is related to conditions of emotional arousal (Kramer & Weber, 2000). However, Obrist (1981) already emphasized the importance of the sympathetic nervous system during performance of cognitive tasks. Recently, Iani et al. (2004) showed that finger pulse amplitude decrease was associated with investing effort during task performance. Iani et al. suggested that peripheral vasoconstriction is a sensitive index of sympathetic activation related to mental load. They explained that normal sympathetic tone keeps almost all peripheral blood vessels constricted to about half of their maximum diameter. With increased sympathetic activity peripheral vessels can be further constricted.

Podlesny and Raskin (1978) examined the efficiency of a plethysmographic measure in both GKT and CQT (Comparison Question Technique) interrogation methods, and reported significant discrimination between guilty and innocent participants. Similar results were reported for the CQT by Podlesny and Kircher (1999).

It is therefore an object of the present invention to provide an improved method of detecting knowledge of concealed information.

Additional objects and advantages of the invention will become apparent as the description proceeds.

### SUMMARY OF THE INVENTION

The present invention relates to a physiological measurement designed to detect whether an individual is concealing information. The method for obtaining this measurement comprises the steps of:

a. presenting said individual with a series of stimuli over a period of time;

b. determining the response of said individual to said stimuli by measuring the pulse in the finger of said individual to determine cardiovascular changes during said period;

c. analyzing the changes in pulse rate and pulse amplitude in the graphical representations of said measurements;

d. computing the finger pulse waveform line length;

e. analyzing the response of said individual by analyzing said length to determine whether said individual is concealing information.

According to a preferred embodiment, the stimuli are questions asked to the individual.

The line length is computed by determining the distance between each consecutive coordinate pair of pixels in the graphical representation of the measurements. The line length that is analyzed is the total line length during the 15 s interval following stimulus onset.

Preferably, the questions are presented visually on a computer screen and/or are read aloud to the individual, and the questions include one relevant and at least one control alternative.

The procedure for determining whether the individual is concealing information comprises:

a. assigning a score to the response to each question based on the strength of the response to the relevant and irrelevant portions of the question;

b. summing up the scores for all questions to provide a single detection score;

c. setting a cutoff score according to the detection procedure; and,

d. determining whether the detection score is above or below said cutoff score.

The strength of the response is determined based on the length of the line, wherein a shorter line length in comparison to another line indicates a stronger response.

### BRIEF DESCRIPTION OF THE FIGURES

In the figures:

FIG. 1 shows details of the experimental method used in Table 1, comprising six profiles, each defined by particular items, and used during experimentation;

FIG. 2 graphically illustrates finger pulse wave tracings;

FIG. 3 shows the results of correct classifications from Example 1 in Table 2;

FIG. 4a shows statistics related to the ROC curve for Example 1, in Table 3;

FIG. 4b shows an ROC curve drawn to illustrate the efficiency of the Finger Pulse Wave Length in Example 1;

FIG. 5 shows Table 4 with the detection rates computed for three physiological measures; and,

FIG. 6 shows statistics related to the ROC curve for Example 1, in Table 3.

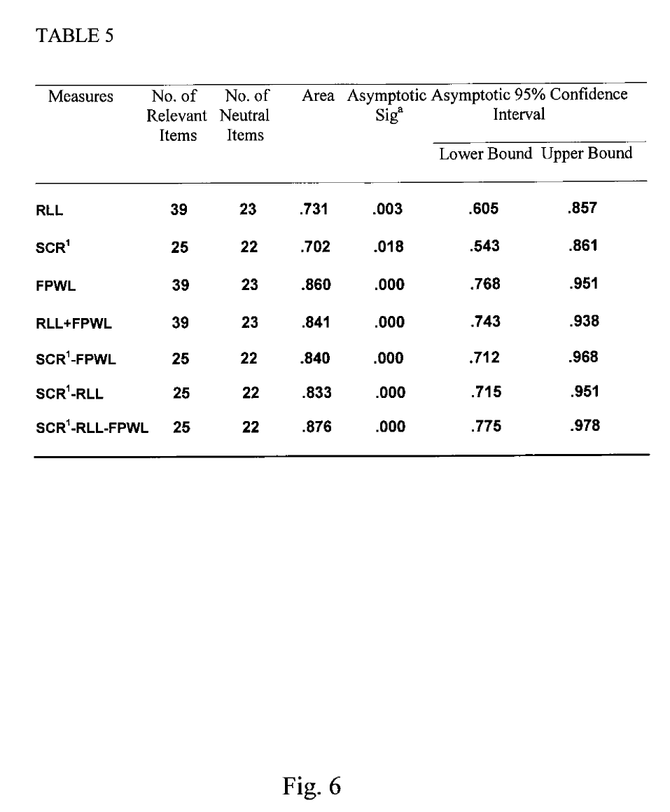

### DETAILED DESCRIPTION OF PREFERRED EMBODIMENTS

Various forms of lie detector tests are used in effort to determine whether information is being concealed by an individual. Physiological responses to specific types of questioning are measured for indicating knowledge of concealed information. It is reasonable to expect that the use of additional physiological measurements will yield even more accurate results. In the present invention, vasoconstriction in the finger of an individual is measured and used as an accurate method of detecting concealed information.

The term, “concealed information” as used herein refers to information known by an individual, which he/she is attempting to conceal. The term, “detecting concealed information” is used herein to refer to the method or methods used to reveal the fact that the individual is knowledgeable of and is attempting to conceal information. The information could be of any type, such as knowledge of unlawful activity.

According to the present invention, the finger is chosen for measurement of peripheral vasoconstriction because it contains a high concentration of alpha-adrenergic receptors, which are responsible for sympathetic constriction. The decrease in finger pulse amplitude (to be defined herein below), for instance, reflects the attention that the guilty suspect invests to identify information in the GKT, as described above. The combination of both tonic and phasic changes in peripheral blood vessels into one measurement even further promotes detection accuracy. Thus, according to the present invention, an individual is presented with a series of stimuli, in particular, questions related to the concealed information. Cardiovascular changes are measured from the blood flow in the finger, and the finger pulse waveform length (FPWL) is computed. The FPWL combines pulse rate and pulse amplitude, as described herein below. Pulse rate slowing and a decrease in pulse amplitude are reflected by shorter line length than that of a normal finger pulse waveform. In other words, the shorter the line, the stronger is the response.

The FPWL is useful in distinguishing between relevant and neutral items in knowledgeable, guilty, examinees. Moreover, the FPWL is a useful measure for discriminating between guilty and innocent examinees in a laboratory GKT setting. Furthermore, the FPWL maintains its accuracy in situations where other measures (e.g., SCR) are less effective (e.g., when participants are tired or bored).

Habituation is a gradual decrease in response as a function of the number of repetitions of the stimuli. SCR measurements exhibit habituation faster than do FPWL measurements, which consists of two components: HR deceleration and pulse volume suppression. Thus, measures of sympathetic activity, which are less affected by habituation, can better serve for a longer period of interrogation under less than optimal conditions.

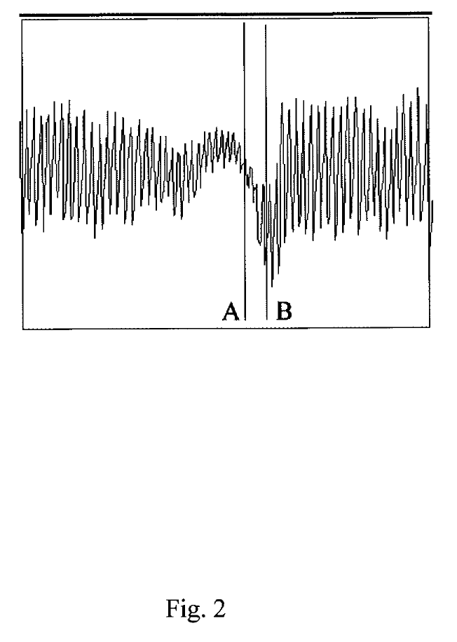

The line length of the finger pulse waveform is defined herein as the distance between each consecutive coordinate pair of pixels. FIG. 2 graphically illustrates an example of finger pulse wave tracings, as described herein below. The line length value may be calculated using the Pythagorean theorem, as described below:

FPWL=SQRT(dT²+dA₁²)+SQRT(dt²+dA₂²)+ . . . +SQRT(dT²+dAₙ²)

### Wherein,

dT=the difference in time (expressed in milliseconds) between two subsequent data points.

dA=the difference in amplitude (expressed in AD-values) between two subsequent data points.

n=the number of data points in the measured time period (1+15 sec.).

Alternatively, any known method for determining the distance between each consecutive coordinate pair of pixels may be used.

After obtaining the desired measurements various procedures may be used to determine whether the individual is concealing information. One example of such a procedure was developed by D. Lykken, as described herein below.

### EXAMPLES

### Example 1

### Experimental Procedure

Thirty males and ten females, consisting of college students and staff, participated in the mock-crime experiment. Participants were recruited through advertisements placed on notice boards around the campus, and were paid 30 NIS (approximately $6.5) for their participation. The mean age of the participants was 26.7 years (SD=7.2 years).

Skin conductance was measured by a constant voltage system (0.5 V Atlas Researches Ltd. Israel). Two Ag/AgCl Grass electrodes (0.8 cm diameter) were used with a 0.05 M NaCl electrolyte paste.

Respiration was recorded by an Atlas Researches piezoelectric belt positioned around the thoracic area.

Finger pulse was recorded using an Atlas Researches piezoelectric plethysmograph positioned around the right hand thumb. The plethysmograph measures pressure changes accompanying the blood volume pulse. An increase in these values represents vasodilation whereas a decrease reflects vasoconstriction. The plethysmograph showed also the interpulse interval between two successive pulse waves.

The experiment was conducted in an air conditioned laboratory, and was monitored from a control room separate from the laboratory by a one way mirror. A serial communical link from DAS (Data Acquisition System), was split in parallel into the serial ports of two separate Pentium 4 PC computers. One controlled the stimulus presentation and computed skin conductance, respiration and cardiovascular changes. The stimuli were displayed on a 15 inch color screen positioned in front of the examinee. The other displayed the graphs in real time on a 15 inch color screen in front of the experimenter in the control room. The graphs were recorded for later visual analysis and artifact control.

### Method

Participants were ordered according to their month of birth and were asked to select one out of six instruction sheets which were situated on a small table. Each instruction sheet directed the participant to enter an office and to search for a colored envelope located in a specified place. In order to get to the envelope the participant had to remove an object. The participant was told to open the envelope, which contained a sum of money ranging from 40 to 70 NIS (approximately $9-$16), an article of jewelry and a writing instrument. The participant was told to take the money and hide it in his/her pocket. Finally each participant was requested to drink a beverage, which was placed on a nearby table.

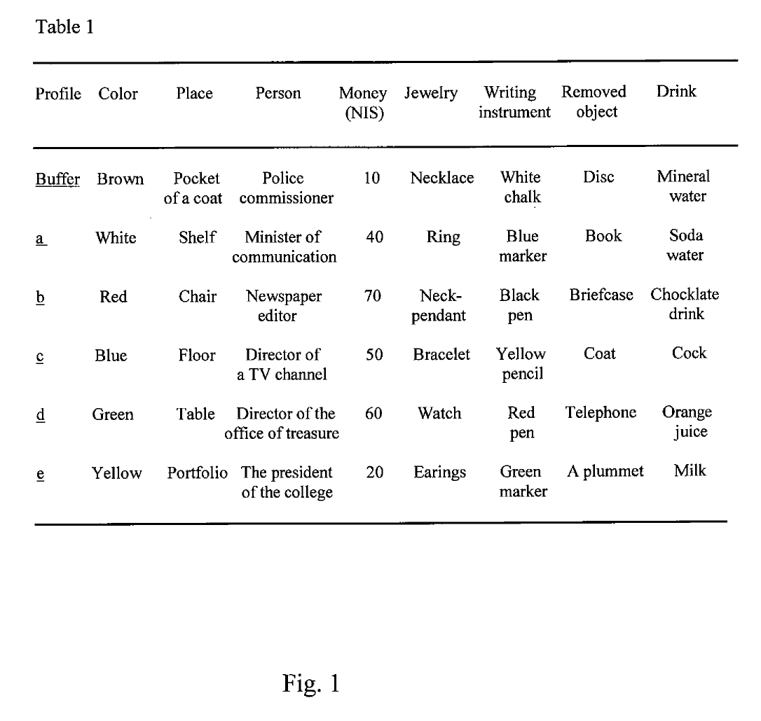

Referring to Table 1 in FIG. 1, one out of four profiles (a)-(d) consisting of the significant items used in the experiment served as the relevant profile for each participant. A fifth profile (e) as well as a buffer profile were used only in the interrogation phase of the experiment, but were never used as the relevant profile.

To confirm that the participants actually followed the instructions, as soon as they completed the mock-crime they were requested to answer a questionnaire in which they named the eight relevant items of their profile. They kept the questionnaire with the responses in their pocket until the end of the experiment. It turned out that seven participants made mistakes in one of the instructions (e.g. by drinking a beverage other than that which they were told to drink).

In the following stage of the experiment, the GKT was administered to all participants. An experimenter, who was unaware of the relevant profile of the particular participant, attached the skin conductance response (SCR) electrodes, the respiration belt and the plethysmograph to the participant and conducted the examination. Participants were told that the experiment was designed to test whether they could cope with the polygraph test and yield an innocent outcome. They were told that the task was difficult and that only people with strong will, superior intelligence and emotional self control can perform it successfully. In addition, they were promised a bonus of 10 NIS (approximately $2) for successful performance of the task as a token of appreciation for their qualifications.

The GKT questions were presented to the participants after an initial rest period of 2 minutes. In that period skin conductance baseline was recorded. Eight different questions were presented, each focusing on a different feature of the mock crime (e.g., the color of the envelope, the person to whom it was addressed, its specific location in the office, the beverage that the culprit drank, the object that the perpetrator removed to get to the envelope, and the article of jewelry, the sum of money, and the writing instrument it contained). The questions were pre-recorded on the computer and were played back to the participant. Simultaneously, the questions were presented to the participant visually on the computer monitor. Each question referred to one relevant and four irrelevant (control) items and was presented only once. A buffer item was presented at the beginning of each question to absorb the initial orienting response. The order of the other five items within each question was random.

The interstimulus interval (i.e. the interval between the presentation of each question) ranged from 16 to 24 s, with a mean interval of 20 s. Participants were instructed to respond verbally with the word, “no” to each item in each question immediately after its presentation. Thus, the participants lied when they answered “no” to the relevant item and told the truth when they responded to the presentation of neutral items. A short break was given after the presentation of four questions. The questions were presented in a random order. After the test was completed, the polygraph was removed from the participant, the participant was debriefed about the purpose of the study, and then paid.

### Electrodermal Response

The participants' responses were transmitted in real time to the computer. SCR was computed using the maximal increase in conductance obtained from the examinee, from 1 to 5 s after stimulus onset.

To eliminate differences in individual responsivity and to permit a meaningful summation of the responses of the different participants, the SCRs were transformed into within-subjects standard scores, computed relative to the mean and standard deviation of the participant's response distribution within each series of 6 items. Within-series Z scores were selected because they are more resistant to habituation effects (Elaad & Ben-Shakhar, 1997).

### Respiration Response

The respiration responses were defined on the basis of the total respiration line length (RLL) during the 15 s interval following stimulus onset. Following Elaad et al. (1992) each response was defined as the mean of 10 length measures (0.1 s after stimulus onset through 15.1 s after stimulus onset, 0.2 s through 15.2 s after stimulus onset, etc.). In other words, ten 15 s windows were created, each beginning 0.1 s later than the previous one, and the RLL was defined as the mean of these 10 length measures. Each RLL was computed using sampling rate of 20 per second. The standardization transformation was similar to that described in relation to the electrodermal measure, but unlike the electrodermal measure, guilty knowledge was reflected by smaller rather than larger RLLS.

### Finger Pulse Waveline Responses

The FPWL responses were defined as the total pulse pattern line length during the 15 s interval following stimulus onset. The line length is disproportionally affected by the starting point of measurement (Elaad et al. 1992; Timm, 1982). Hence, if the starting point coincides with a rapidly descending pulse line, as indicated by (A) in the graph shown in FIG. 2 it may result in a markedly different line length value as compared to a starting point where changes are relatively slow, as indicated by (B) in FIG. 2, for equal time intervals. Since the questions were presented visually on the computer screen and were read aloud to the participant with a slight delay (less than 1 s), the starting point is crucial. A starting point immediately following the onset of the visual stimulus would yield a different value than a starting point occurring after the onset of the oral stimulus. To resolve this problem ten 15 s windows were created, each beginning 0.1 s later than the previous one, and the FPWL was defined as the mean of these 10 length measures. Sampling rate for the FPWL was 20 per second. As indicated earlier, the FPWL combines pulse rate slowing and a decrease in pulse amplitude, which means that the shorter the line the stronger the response. Therefore, smaller Z scores are expected in response to the relevant items compared to the irrelevant items. Z scores were computed relative to the mean and standard deviation of the examinee's FPWL responses within each series of 6 items.

### Results

Lykken's Scoring Procedure

A scoring procedure (Lykken, 1959), which has been often used in GKT studies (e.g., Ben-Shakhar & Elaad, 2002; Bradley & warfield, 1984; Carmel et al., 2003), was employed. According to this procedure, the standardized responses to all the alternatives of each question are ranked. If the relevant alternative elicits the strongest response (smallest Z scores in the case of RLL and FPWL), a score of 2 is assigned to the question; if it elicits the second strongest response, a score of 1 is assigned. Otherwise a score of 0 is assigned to the question. These scores are then summed up for all questions to provide a single detection score. As described above, in the present experiment eight questions were presented, each with one relevant and four neutral items. Thus, the detection score ranged between 0 and 16. A cutoff score of 8 was set according to this detection procedure. This means that a detection score of at least 8 is needed to reach a “guilty” classification for the participant.

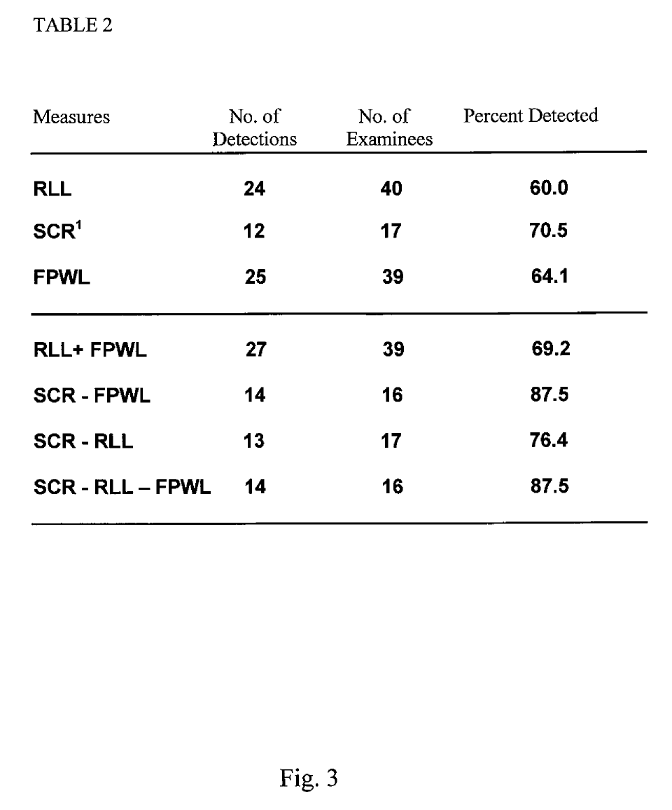

Seven participants had difficulty recognizing one of the items. Therefore, this item was excluded from the analysis and the cutoff score for these participants was set at 7. Results of correct classifications based on this procedure are presented in Table 2 of FIG. 3. (Note: Due to mechanical problems with the SCR measure, data of 19 participants were totally lost and of 4 participants partially lost. Hence, the analyses of the SCR was based on only 17 participants.) As seen in Table 2, the percent of correct classifications computed for the FPWL range in between those computed for the SCR and RLL.

### ROC Analysis

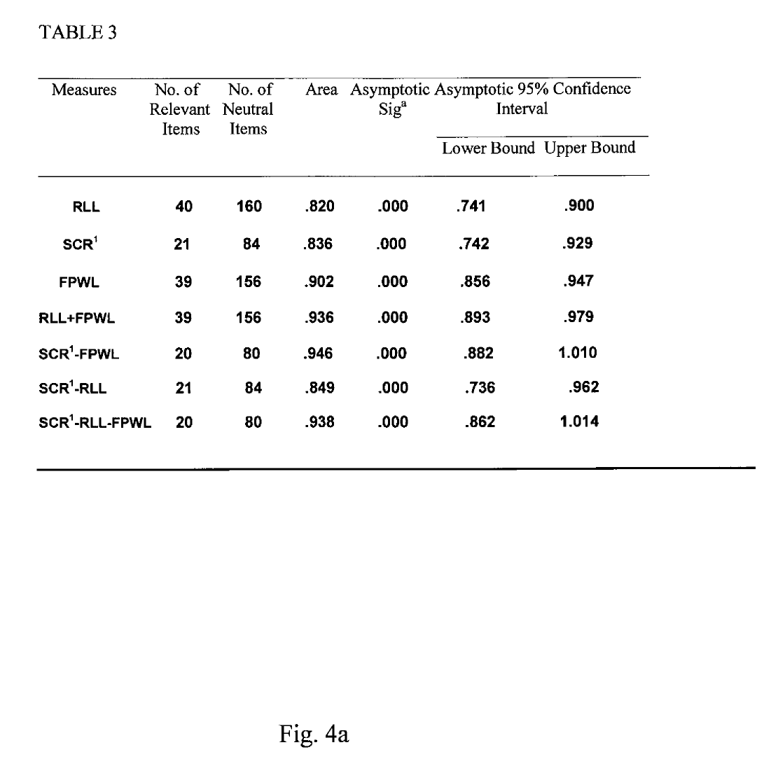

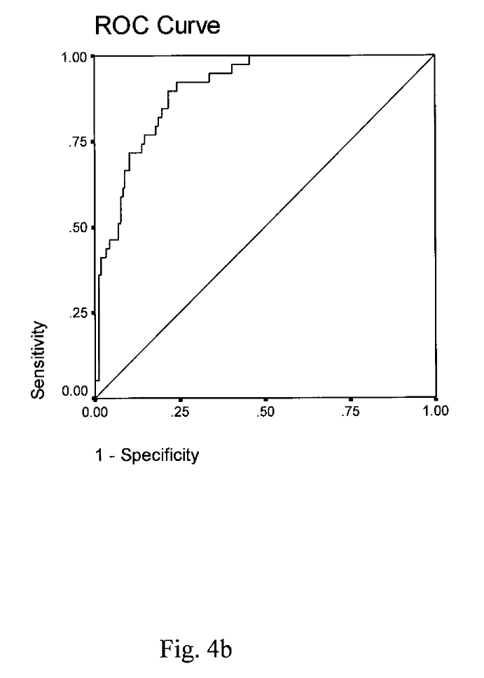

The accuracy rates which were presented thus far depend on a single arbitrary cutoff point which is not necessarily optimal. Therefore, an additional method was used, which is derived from signal detection theory, which has often been used in GKT studies (e.g., Ben-Shakhar, 1977; Elaad & Ben-Shakhar, 1989, 1997, Vossel, et al. 2003), and was recently recommended by the National Research Council Report (2003) as a particularly relevant method for describing the diagnostic value of polygraph tests. In signal detection theory terms, detection efficiency is defined by the degree of separation, between the distributions, of the responses to the relevant and to the neutral items. For this purpose, the distributions of the mean Z scores, computed for each participant for all items of his or her particular profile and the distribution of the mean Z scores computed for each participant across all items of the 4 neutral items were generated for each physiological measure and for each combination of measures. On the basis of these distributions, Receiver Operating Characteristic curves (ROCs) were generated for each measure (FPWL, RLL and SCR), and the areas under these ROC curves, along with the corresponding 95% confidence intervals, were computed (See Bamber, 1975) for each measure and for all combinations of measures and are presented in Table 3 in FIG. 4a. (Note: Due to mechanical problems with the SCR measure, data of 19 participants were lost. Hence, the analyses of the SCR and the combined measures were based on limited sample size.) FIG. 4b shows the ROC curve drawn to illustrate the efficiency of the FPWL. The area under the ROC curve (also labeled A, see Green, 1964) reflects the detection efficiency of the critical items, for all possible cutoff points. It assumes values between 0 and 1, such that an area of 0.5 means that the two distributions (the distributions of the mean Z scores of the critical and neutral items) are undifferentiated. An area of 1 indicates that there is no overlap between the two distributions, and thus they are perfectly differentiated.

The ROC analysis revealed that detection efficiency with all three measures was significantly better than chance. The FPWL efficiency was at least as good as that obtained with the SCR and was better than that obtained for the RLL (note that the area computed for the FPWL falls above the confidence interval of the RLL and the area of the RLL falls below the confidence interval of the FPWL).

Because the RLL and the FPWL provided indications of guilt by lower rather than higher scores, each combination of the three physiological measures was differently defined. The measure that combined RLL and FPWL was defined as a sum of the two Z scores (RLL+FPWL). The measure that combined SCR and FPWL was defined as a difference score (SCR−FPWL). The same was applied for the measure that combined SCR and RLL (SCR−RLL). The measure that combined all three indices was defined as follows (SCR−RLL−FPWL).

As seen in Table 3, detection efficiency was further improved when a combination of FPWL with the other two measures was used.

### Discussion

The results of this experiment suggest that the FPWL may be a useful tool for identification of guilty suspects who are attempting to conceal information. However, the present sample did not include a control group of “innocent participants” (with no guilty knowledge) and the detection efficiency estimates were based on comparisons of relative responses to relevant and neutral items within participants. Furthermore, although unaware of the relevant profile, the experimenter was aware of the fact that all examinees were guilty. It was therefore decided to conduct another experiment, which includes an additional group of innocent participants and in which the experimenter will be blind regarding the guilt or innocence of the participants.

### Example 2

### Experimental Procedure

A total of 62 college students (19 males and 43 females), who had no previous experience as participants in these kind of experiments, were recruited for a lie detection experiment through advertisements placed on notice boards around the campus. The participants' age ranged from 20 to 35 years (mean 23.4, SD=2.4). Participants were offered 30 NIS (approximately $6.5) for participation in the experiment and were told that they may receive a bonus for successful performance.

The apparatus used in this experiment was similar to that used in Experiment 1.

### Method

Example 2 was designed to compare the behavior of both “guilty” and “innocent” participants under two different conditions (e.g., unconnected and connected to the polygraph). Thus, in the first stage participants were told that their task was to cope with a highly professional expert in lie detection who does not need the polygraph to reveal their lies. To this end, participants were instructed to deny knowledge of the eight relevant items while the transducers were not attached to them. In the second stage, the same questions were repeated and the three physiological measures were recorded.

The experiment was conducted by two experimenters. Experimenter A instructed the participants to choose one envelope out of three identical envelopes placed on a small table. Two envelopes contained a note indicating that the participant was assigned to the “guilty condition” and one envelope contained a note which assigned him or her to the “innocent condition”. Participants simulating the guilty condition (N=39) were instructed to enter an office and look for an envelope located in a certain specified place. The remaining instructions were similar to those described in the first experiment (Example 1). Participants simulating the innocent condition were instructed to wait outside the office for 4 minutes (about the time needed to complete the mock-crime). Then, Experimenter A explained that the participants were suspected of committing the crime because someone saw them near the office in which the crime was committed. Experimenter A told all the participants to try to yield a truthful outcome and asked each of them their month of birth. According to the order of their month of birth each participant was assigned one out of four profiles (a)-(d), see Table 1, which was used as the relevant profile for that participant. Finally, the participants were sent to the examination room where Experimenter B was waiting for them. Experimenter B who was unaware of the guilt or innocence of the participants attached the polygraph devices and conducted the GKT examination. Participants were told that the experiment was designed to test whether they could cope with an experienced human lie catcher (a professional analyst who will focus on their micro-behavior), as well as with a mechanical lie detector—the polygraph. Participants were told that the task was difficult and that only people with strong will, superior intelligence and emotional self-control can succeed in it. They were promised a bonus of 10 NIS (approximately $2) if they would yield an innocent outcome in both tests. The two experimenters alternated such that each tested about half of the total number of examinees.

Before the questions were presented for the first time, while the transducers were not attached to them, participants were instructed to deny knowledge of the eight relevant items. They were told that they were being videotaped and an expert in lie-detection will try to reveal whether they deceived by inspecting their verbal and non-verbal behavior. In the second stage, the same questions were repeated while SCR, RLL and FPWL were recorded.

### Results

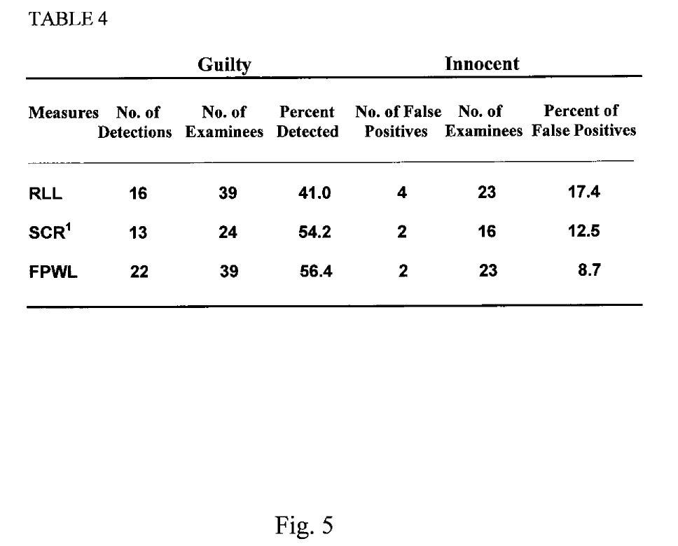

Detection rates were defined according to Lykken's (1959) procedure with a cutoff score of at least 8 to indicate a “guilty” classification, as described above for Example 1. It turned out that eight examinees had difficulty in recognizing one of the eight relevant items. This item was excluded from the analysis and the cutoff score for these participants was set at 7. The correct and incorrect detection rates computed for the three physiological measures are displayed in Table 4 of FIG. 5. (Note: Due to mechanical problems with the SCR measure, data of 15 guilty and of 7 innocent participants were partially or totally lost. Hence, the analyses of the SCR was based on only 24 guilty and 16 innocent participants.)

The inclusion of innocent participants allows for a different definition of the detection efficiency using false positive rates (false detections) of innocent participants. Table 4 reveals that the RLL, SCR and FPWL produced larger true positive rates (detections of guilty examinees) than false positive rates. Table 4 further shows that there is a clear advantage of the FPWL over the other two indices, by resulting in the largest detection rate and the smallest false positive error rate. The RLL turned out as the poorest detection measure, with the lowest rate of true positives and the highest false positive rate.

Signal detection measures compare the distributions of the mean Z scores, computed for all the relevant items, of guilty and innocent examinees, as described above for Example 1. Applying signal detection analysis to the results of Example 2 demonstrate the advantage of the FPWL over the SCR and RLL. Table 5 displays these results, which reveal that all three measures significantly differentiated between guilty and innocent examinees and that the RLL and SCR were less effective than FPWL. (Note: Due to mechanical problems with the SCR measure, data of 14 guilty and of 1 innocent participants were totally lost. Hence, the analyses of the SCR was based on only 25 guilty and 22 innocent participants.) The ROC analysis reveals that the area computed for the FPWL falls above the confidence interval of the RLL and the area of the RLL falls below the confidence interval of the FPWL. Detection efficiency was not further improved when a combination of FPWL with any one of the other two measures was applied, but a small improvement was revealed when a combination of all three measures was used.

### Discussion

The second experiment presented lower identification rates than the first, which may be explained by habituation of the physiological responses during the second presentation of the question series, and by lack of interest in the task at the final stages of the experiment. This was clearly expressed by many examinees during the debriefing.

Based on the first experiment the FPWL may be useful in separating relevant from neutral items in knowledgeable, guilty, examinees. The results from the second experiment reveal that the FPWL may be a useful measure for discriminating between guilty and innocent examinees in a laboratory GKT setting. Furthermore, the FPWL seems to maintain its accuracy in situations where other measures are less effective (e.g., when participants were tired or bored). Habituation may also explain the results. Habituation is a gradual decrease in responding as a function of the number of repetitions of the stimuli. SCR and RLL seem to habituate faster than FPWL, which consists of two components, HR deceleration and pulse volume suppression.

Bradley, et al. (1993) detected rapid skin conductance habituation to the presentation of arousing stimuli (pleasant and unpleasant pictures). This is in line with Sokolov's (1963) theory of the OR, according which a simple stimulus repetition quickly comes to match a neural model in the sensory cortex, which inhibits the OR. However, HR deceleration does not totally submit to the OR rules. Bradley et al. (1993) reported a strong initial HR deceleration to their arousing stimuli, which habituated within the first out of three blocks of 24 trials. However, later on, there was a strong initial responding (HR deceleration) to the presentation of unpleasant pictures but no habituation was observed. Bradley et al. (1993) argued that whereas sweat glands that mediate electrodermal activity are controlled only by the sympathetic system the heart rate is controlled by both the sympathetic and parasympathetic systems, as well as by vascular mechanics and circulating hormones. As a result there is enhanced noise, which makes it more difficult to detect stimulus habituation. Similarly, Furedy (1968) demonstrated that whereas the SCR showed the expected pattern of habituation with repeated presentations of the stimuli, the cardiovascular measure (digital blood volume pulse change) did not display any habituation.

Thus, FPWL was examined under less favorable conditions than in the first experiment and succeeded more than the other two measures (SCR and RLL) to cope with these difficulties.

It seems that SCR, which has been extensively researched during the past 3 decades (see Ben-Shakhar & Elaad, 2003), correspond best to the OR model. The FPWL may be less sensitive to habituation than SCR, and this finding is important from a practical perspective. Measures of sympathetic activity, which are less affected by habituation, can serve for a longer period of interrogation under less than optimal conditions.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

### BIBLIOGRAPHY

1. Bamber, D., 1975The area under the ordinal dominance graph and the area below the receiver operating characteristic graph. J. of Mathematical Psychol. 12, 378-415.

2. Ben-Shakhar, G., 1977. A further study of the dichotomization theory in detection of information. Psychophysiology 14, 408-413.

3. Ben-Shakhar, G., Dolev, K., 1996. Psychophysiological detection through the guilty knowledge technique: Effects of mental countermeasures. J. of Applied Psychol. 81, 273-281.

4. Ben-Shakhar, G., Elaad, E., 2002. Effects of questions repetition and variation on the efficiency of the guilty knowledge test: A reexamination. J. of Applied Psychol. 87, 972-977.

5. Ben-Shakhar G., Elaad, E., 2003. The validity of psychophysiological detection of information with the Guilty Knowledge Test: A meta-analytic review. J. of Applied Psychol. 88,131-151.

6. Ben-Shakhar, G., Furedy, J. J., 1990. Theories and applications in the detection of deception. New York: Springer-Verlag.

7. Ben-Shakhar G., Gronau, N. Elaad, E., 1999. Leakage of relevant information to innocent examinees in the GKT: An attempt to reduce false-positive outcomes by introducing target stimuli. J. of Applied Psychol. 84, 651-660.

8. Bradley, M. M., Lang, P. J., Cuthbert, B. N., 1993. Emotion, novelty, and the startle reflex: Habituation in humans. Behavioral Neuroscience 107, 970-980.

9. Bradley, M. T., Ainsworth, D., 1984. Alcohol and psychophysiological detection of deception. Psychophysiology 21, 63-71.

10. Bradley, M. T., Janisse, M. P., 1981. Accuracy demonstration, threat, and the detection of deception: Cardiovascular, electrodermal, and pupillary measures. Psychophysiology 18, 307-315.

11. Bradley, M. T., & Warfield, J. F., 1984. Innocence, information, and the guilty knowledge test in the detection of deception. Psychophysiology 21, 683-689.

12. Carmel, D., Dayan, E., Naveh, A., Raveh, O., Ben-Shakhar, G., 2003. Estimating the validity of guilty knowledge test from simulated experiments: The external validity of mock crime studies. J. of Experimental Psychol.: Applied, 9, 261-269.

13. Elaad, E., 1990. Detection of guilty knowledge in real-life criminal investigations. J. of Applied Psychol. 75, 5, 521-529.

14. Elaad, E., Ben-Shakhar, G., 1989. Effects of motivation and verbal response type on psychophysiological detection of information. Psychophysiology 26, 442-451.

15. Elaad, E., Ben-Shakhar G., 1997. Effects of item repetitions and variations on the efficiency of the guilty knowledge test. Psychophysiology 34, 587-596.

16. Elaad, E., Ginton, A., Jungman, N., 1992. Detection measures in real-life criminal guilty knowledge tests. J. of Applied Psychol. 77, 757-767.

17. Furedy, J. J., 1968. Human orienting reaction as a function of electrodermal versus plethismographic response modes and single versus alternating stimulus series. J. of Experimental Psychol. 77, 70-78.

18. Godert, H. W., Vossel, G., Rill, H. G., Busuttil, A., Ashcroft, K. R., 2003. Forensic psychophysiology: The utility of phasic heart rate for the differentiation of guilty knowledge, innocent knowledge, and lack of knowledge about crime details. J. of Psychophysiology, 17, 105. Abstract.

19. Graham, F. K., 1979. Distinguishing among orienting, defensive and startle reflex. In: Kimmel, H. D., van Olst, E. H., Orlebeke J. F., (Eds.), The orienting reflex in Humans. Hillsdale, N.J.: Erlbaum. pp. 137-167.

20. Green, D. M., 1964. General predictions relating yes-no and forced choice results. J. of the Acoustical Society of America, 35, 1042.

21. Hirota, A., Sawada, Y., Tanaka, G., Nagano, Y., Matsuda, I., Takasawa, N., 2003. A new index for psychophysiological detection of deception: Applicability of normalized pulse volume. Japanese Journal of Physiological Psychology and Psychophysiology 21, 217-230.

22. Iani, C., Gopher, D., Lavie, P., 2004. Effects of task difficulty and invested mental effort on peripheral vasoconstriction. Psychophysiology 41, 789-798.

23. Kramer, A. F., Weber, T., 2000. Applications of psychophysiology to human factors. In: Cacioppo, J. T., Tassinary, L. G., Berntson, G. G. (Eds.), Handbook of psychophysiology. New York: Cambridge University Press. pp. 794-814.

24. Lykken, D. T., 1959. The GSR in the detection of guilt. J. of Applied Psychol. 43, 385-388.

25. Lykken, D. T., 1974. Psychology and the lie detection industry. American Psychologist 29, 225-239.

26. Lykken, D. T., 1998. A Tremor in the blood. Uses and abuses of the lie detector. Second edition. New York: Plenum Trade. National Research Council., 2003. The Polygraph and Lie Detection. Committee to Review the Scientific Evidence on the Polygraph. Division of Behavioral and Social Sciences and Education. Washington, D.C.: The National Academies Press.

27. Obrist, P. A., 1981. Cardiovascular psychophysiology: A perspective. New York: Plenum.

28. Podlesny, J. A., Raskin, D. C., 1978. Effectiveness of techniques and physiological measures in the detection of deception. Psychophysiology, 15, 344-358.

29. Pollina, D. A., Dollins, A. B., Senter, S. M., Krapohl, D. J., Ryan, A. H., 2004. Comparison of polygraph data obtained from individuals involved in mock crimes and actual criminal investigations. J. of Applied Psychol. 89, 1099-1105.

30. Raskin, D. C., 1979. Orienting and defensive reflexes in the detection of deception. In: Kimmel, H. D., van Olst, E. H., Orlebeke, J. F., (Eds.), The orienting reflex in humans. Hillsdale, N.J.: Erlbaum. pp. 587-605.

31. Sokolov, E. N., 1963. Perception and the conditioned reflex. New York: Macmillan.

32. Timm, H. W., 1982. Analyzing deception from respiration patterns. J. of pol. Science and Adm. 10, 47-51.

33. Verschuere, B., Crombez, G., De Clercq, A., Roguska, J., 2004. Autonomic and behavioral responding to concealed information: Differentiating orienting and defensive responses. Psychophysiology 41, 461-466.

34. Vossel, G., Gamer, M., Godert, H. W., Rill, H. G., 2003. The efficiency of detecting concealed information with the Guilty Knowledge Test: A comparison of different physiological variables and non-physiological methods of credibility assessment using signal detection theory. J. Psychophysiol. 17, 184. abstract

1. A method of detecting whether an individual is concealing information, said method comprising the steps of:
a. presenting said individual with a series of stimuli over a period of time;
b. determining the response of said individual to said stimuli by measuring the pulse in the finger of said individual to determine cardiovascular changes during said period;
c. analyzing the changes in pulse rate and pulse amplitude in the graphical representations of said measurements;
d. computing the finger pulse waveform line length;
e. analyzing the response of said individual by analyzing said length to determine whether said individual is concealing information.

2. A method according to claim 1, wherein the stimuli are questions asked to the individual.

3. A method according to claim 1, wherein line length is computed by determining the distance between each consecutive coordinate pair of pixels in the graphical representation of the measurements.

4. A method according to claim 1, wherein the line length that is analyzed is the total line length during the 15 s interval following stimulus onset.

5. A method according to claim 2, wherein the questions are presented visually on a computer screen

6. A method according to claim 2, wherein the questions are read aloud to the individual.

7. A method according to claim 2, wherein the questions include one relevant and at least one control alternative, and wherein the procedure for determining whether the individual is concealing information comprises:
a. assigning a score to the response to each question based on the strength of the response to the relevant and irrelevant portions of the question;
b. summing up the scores for all questions to provide a single detection score;
c. setting a cutoff score according to the detection procedure; and,
d. determining whether the detection score is above or below said cutoff score.

8. A method according to claim 7, wherein the strength of the response is determined based on the length of the line, wherein a shorter line length in comparison to another line indicates a stronger response.
